(19) United States
(12) Patent Application Publication
(10) Pub. No.: US 2021/0110323 A1
(43) Pub. Date: Apr. 15, 2021

(54) OPTIMIZING CHARGING, FUELING, AND PARKING OVERHEADS OF FLEET VEHICLES IN A MAAS ARCHITECTURE

(71) Applicants: Juan Pablo Munoz, Folsom, CA (US); Ignacio J. Alvarez, Portland, OR (US); Arvind Merwaday, Beaverton, OR (US); Satish Chandra Jha, Portland, OR (US); Ned M. Smith, Beaverton, OR (US); Vesh Raj Sharma Banjade, Portland, OR (US); S M Iftekharul Alam, Hillsboro, OR (US)

(72) Inventors: Juan Pablo Munoz, Folsom, CA (US); Ignacio J. Alvarez, Portland, OR (US); Arvind Merwaday, Beaverton, OR (US); Satish Chandra Jha, Portland, OR (US); Ned M. Smith, Beaverton, OR (US); Vesh Raj Sharma Banjade, Portland, OR (US); S M Iftekharul Alam, Hillsboro, OR (US)

(21) Appl. No.: 17/131,704

(22) Filed: Dec. 22, 2020

(51) Int. Cl. G06Q 10/06

(52) U.S. Cl. CPC G06Q 10/06311

(57) ABSTRACT

A system for managing a fleet of vehicles in a MaaS network includes a scheduling subsystem configured to retrieve vehicle parameters associated with the fleet of vehicles, the vehicle parameters including a range of travel estimate for each of the vehicles in the fleet. The subsystem retrieves infrastructure resource availability information associated with at least one infrastructure resource used by the fleet of vehicles, and historical usage information associated with the at least one infrastructure resource. The subsystem applies a machine learning technique using the vehicle parameters, the infrastructure resource availability information, and the historical usage information to generate a scheduling instruction. The scheduling instruction is communicated to the fleet of vehicles, the scheduling instruction for scheduling usage of the at least one infrastructure resource by one or more of the vehicles in the fleet.

### TECHNICAL FIELD

Embodiments described herein generally relate to vehicle management systems, and in particular, to optimizing resources of fleet vehicles, including charging, fueling, and parking overheads of fleet vehicles in a network architecture (e.g., a Mobility-as-a-Service (MaaS) network architecture).

### BACKGROUND

In MaaS network architecture, charging or refueling fleet vehicles by getting them to drive to the charging/gas station may not be an efficient process, especially during peak traffic hours. Similarly, for parking, letting the fleet vehicles drive around to find parking spots on their own will also lead to inefficient fleet management.

### BRIEF DESCRIPTION OF THE DRAWINGS

Some embodiments are illustrated by way of example, and not limitation, in the figures of the accompanying drawings in which:

FIG. 1 illustrates a MaaS network using a fleet management system with a charging/fueling/parking control system (CFPCS), according to an example embodiment;

FIG. 2 illustrates example use cases associated with the CFPCS, according to an example embodiment;

FIG. 3A illustrates a machine learning (ML) based scheduling subsystem (MLSS) of the CFPCS of FIG. 1, according to an example embodiment;

FIG. 3B is a block diagram illustrating the training of the deep learning (DL) model used by the MLSS of FIG. 3A, according to an example embodiment;

FIG. 3C illustrates the structure of a neural network which can be used by the MLSS of FIG. 3A, according to an embodiment;

FIG. 4 illustrates a system overview for another example of a fleet management system with quality of service (QoS) optimization via predictive recharging/refueling, according to an example embodiment;

FIG. 5 illustrates a map representation of Portland, Oregon metropolitan area with service zones represented as hexagonal grids and existing demand/fleet resources represented with icons, according to an example embodiment;

FIG. 6 illustrates dynamic service area boundary calculations based on demand and serviceability prediction on a time horizon, according to an example embodiment;

FIG. 7 illustrates a dynamic MaaS service area map combining user demand predictions with fleet range predictions, according to an example embodiment;

FIG. 8 illustrates an initial deployment of a fleet of vehicles to expected source hotspots, according to an example embodiment;

FIG. 9 illustrates an example of a cluster that groups several vehicles that will be serviced by a mobile charging station, according to an example embodiment;

FIG. 10 is a flowchart illustrating a method for managing a fleet of vehicles, according to an example embodiment; and

FIG. 11 is a block diagram illustrating an example machine upon which any one or more of the techniques (e.g., methodologies) discussed herein may perform, according to an example embodiment.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

In a MaaS network, a fleet of vehicles may include autonomous vehicles (AVs), non-autonomous vehicles, or semi-autonomous vehicles associated with a ride-sharing service, a delivery service, or another type of service. The vehicles in the fleet may need to travel to the charging/gas station or find a parking spot that consumes more fuel and time, causes more road traffic in already dense urban areas, and causes crowding at the charging/gas stations which might lead to prolonged waiting time.

One technique to address these issues is by adding centralized facilities in a city for charging/fueling/parking of fleet vehicles in the locations of interest. However, this can significantly increase capital expenditures (CAPEX) and operational expenditures (OPEX) for the MaaS deployment and fleet management. Moreover, having just a few centralized facilities may not be enough to solve the parking problem of fleet vehicles that are temporarily off-service.

In some aspects, online marketplace sharing platforms may be used for shared parking and electric vehicle (EV) charging. In such platforms, the property owners can rent their parking spaces and EV charging units (if available) by listing them via the online platform. This solution is designed for scenarios where the consumers are the vehicles of the general public, and the service providers (mobile charging/fueling, online marketplace parking sharing) are separate entities that cannot obtain any real-time information about the consumer vehicles (e.g., fuel level, route planning, etc.). However, the charging, fueling, and parking in a MaaS network are handled differently. In a MaaS network, the consumers (fleet vehicles) and the service provider come under the same entity. The service provider has full command over the fleet vehicles and also has detailed real-time information from the vehicles such as the route planning, charge/fuel level, real-time traffic information, etc. Hence, the previous solutions are not suitable for the MaaS network as they do not exploit the real-time information from fleet vehicles and the command over those vehicles to optimize the charging/fueling/parking overhead operations.

Disclosed techniques may be used for fleet management in the MaaS network to efficiently and automatically handle the charging/refueling/parking operations. More specifically, the disclosed fleet management system takes advantage of the fact that it can have full command over the operations of the fleet vehicles and can obtain real-time detailed information from these vehicles. The proposed fleet management system can be configured with the following example functionalities:

(a) A mobile energy distribution system in which energy distribution vehicles (EDVs), specialized service vehicles for carrying and distributing charge/fuel, are deployed to distribute charge/fuel to clusters of fleet vehicles (following local regulations for fuel delivery).

(b) Mobile recharging while driving using induction coils where a vehicle with excess charge capacity, fuel cell, hybrid fuels may be able to transfer an electric current over induction coils mounted in the rear to front-facing bumpers or side-by-side fenders where autonomous vehicles (AV) and self-driving system (SDS) automation systems position induction coils in close proximity and where a V2V network (such as Bluetooth and WiFi direct) or induction coil connectivity may transmit micropayment protocols to conduct recharging “stops” without stopping. This technology enables new services opportunities for a mobile recharging infrastructure that doesn't require on-off ramps and capital investment in fixed recharging “stations”.

(c) A machine learning (ML) based scheduling subsystem (MLSS) is used as an intelligent scheduling engine in the proposed fleet management system. The MLSS is configured to use one or more machine learning techniques to make optimized decisions and commands for the fleet vehicles and EDVs to carry out these overhead operations in such a way that minimizes the traffic congestions and improves the overall fuel/charge economy of the system.

(d) The proposed framework integrates with an information-sharing subsystem (ISS) which can be configured as an online marketplace sharing platform and when combined with the MLSS can provide benefits to the fleet management. The ISS allows the property owners (residential, enterprise, etc.) to rent-out their facilities (such as parking spaces and/or charging units) to the fleet vehicles and can earn monetary rewards via the micro-payments system.

(e) A distributed ledger technology (DLT) subsystem (DLTS) can be configured to perform functions associated with a micro-payment framework for exchanging value for power where value can be in the form of digital currency or information assets or e-contracts.

Some of the advantages of the disclosed fleet management system include efficiently handling frequent overheads in the MaaS fleet management: refueling, charging, and parking, to achieve efficient route planning and thereby improving service throughput of the MaaS network. The proposed online marketplace platform of the ISS opens-up additional resources (residential, enterprise, etc.) for efficiently managing the EV charging and fleet parking overheads.

Payment integration (e.g., via the DLTS) allows multiple points of efficiency improvement to be rewarded directly—before a mature value change can be put into place. For example, if a fleet management recharging vehicle can draw power from a nearby solar array then introducing the solar array provider into the value change requires little extra effort as an e-contract can authorize the fleet vehicle to connect to the solar array and process payment immediately in whatever form of e-currency was determined by the e-contract. This could include contracts for commodities, stocks, information assets as well as e-currencies such as stable-coin, bitcoin as well as traditional currencies such as dollars, euros, etc.

### Fleet Management System Overview

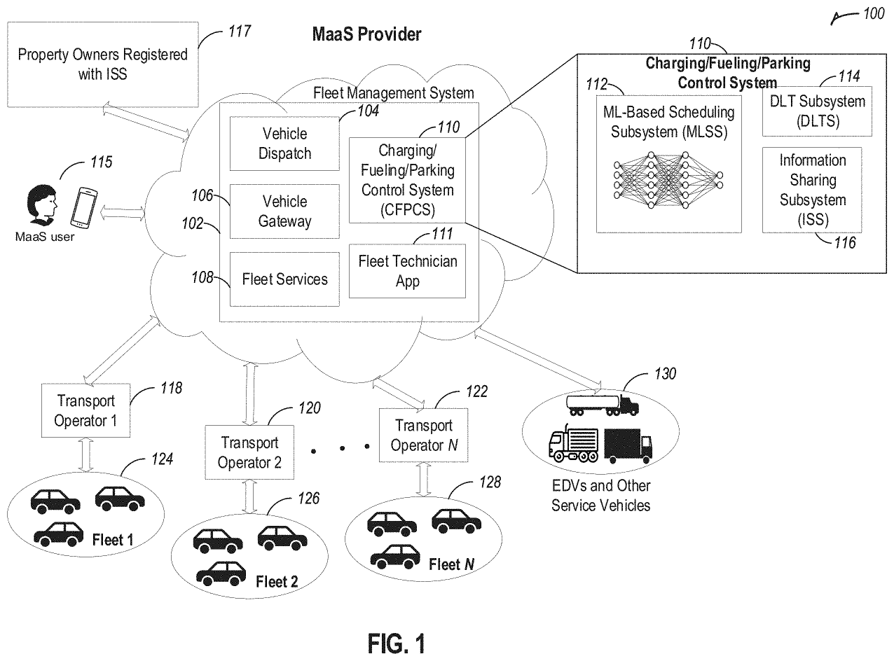

To optimize the charging/fueling/parking overheads of the fleet vehicles and also to automate these operations, the disclosed techniques may use a fleet management system as illustrated in FIG. 1.

FIG. 1 illustrates a MaaS network 100 using a fleet management system 102 with a charging/fueling/parking control system (CFPCS), according to an example embodiment. The MaaS network 100 includes the fleet management system 102 which can be communicatively coupled to vehicle fleets 124, 126, . . . , 128 associated with corresponding transport operators 118, 120, . . . , 122. The fleet management system 102 is further communicatively coupled to EDVs and other service vehicles 130, a MaaS user 115, and property owners 117 registered with the information sharing subsystem (ISS) 116 of the CFPCS 110.

The fleet management system 102 may include a vehicle dispatch subsystem 104, a vehicle gateway 106, fleet services system 108, CFPCS 110, and fleet technician application 111 The CFPCS 110 may include the MLSS 112, DLTS 114, and ISS 116.

FIG. 1 illustrates a high-level model of a MaaS system that comprises fleets of vehicles 124, . . . , 128 which provide a means of transportation to people or goods. The fleet vehicles may be provided and managed by different transport operators (TOs) 118, 122. However, it is assumed that the MaaS provider (e.g., a service operator managing the fleet management system 102) is given control over the operations of the fleet vehicles.

Fleet vehicles 124, . . . , 128 may consist of one or more MaaS Nodes. A MaaS node is a building block compute platform that integrates various essential computational elements that are common to MaaS computing. By building the fleet management solution around fleet vehicles based on a MaaS node architecture, manufacturing economies of scale more easily allow in-expensive yet high quality/reliability MaaS systems. The MaaS node typically consists of a sensor hub, context sensors (location, speed, heading, ambient temperature, accelerometer. ALS, decibels, air quality), context manager, task request/resp handler, message bus, RAN connectivity/comms manager, compute/compute accelerator (xPU), autonomous controller module, micro-payment manager, MaaS orchestration scheduler/task manager, etc.

The fleet vehicles 124, . . . , 128 need to be charged/refueled/parked recurrently which is an overhead that needs to be handled efficiently. In densely populated urban cities, it might be necessary to deploy a large fleet to satisfy the demand, which in turn would increase these overheads. If the charging/fueling/parking operations are not handled efficiently, it can lead to traffic congestions and become a bottleneck resulting in the saturation of service throughput of the MaaS system.

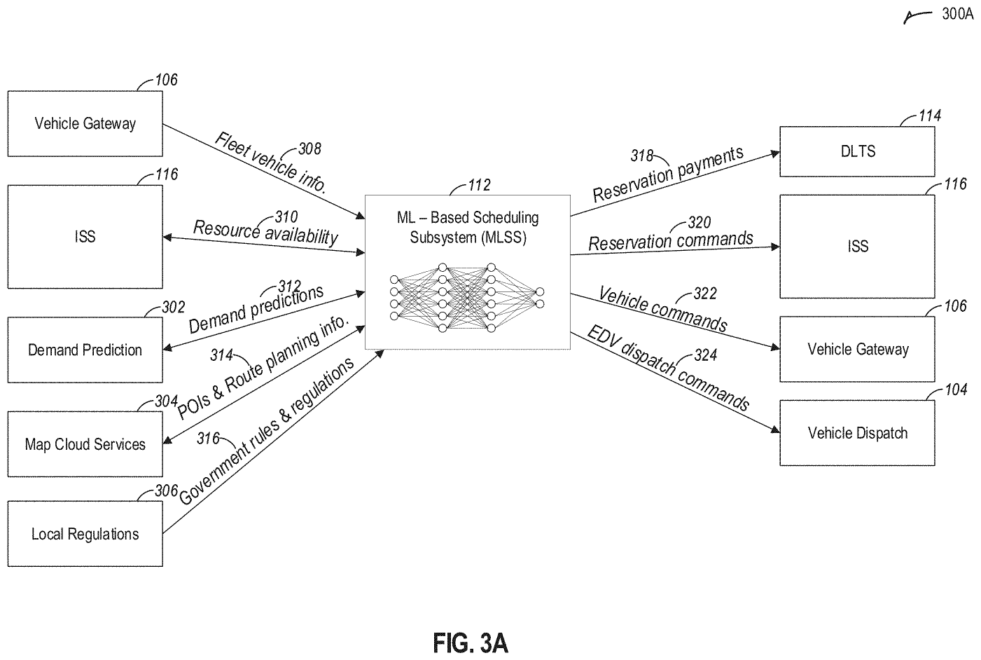

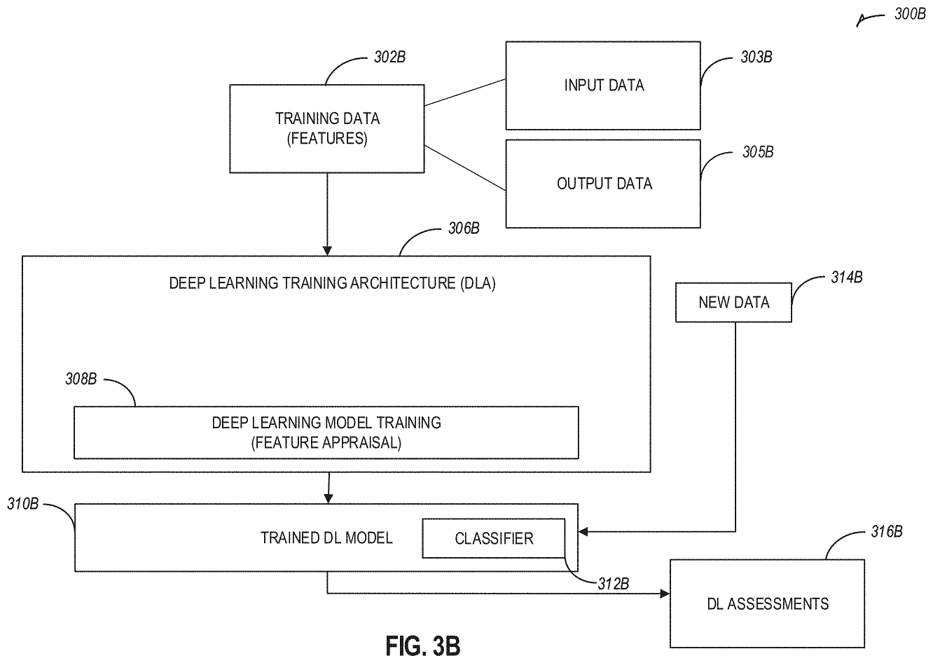

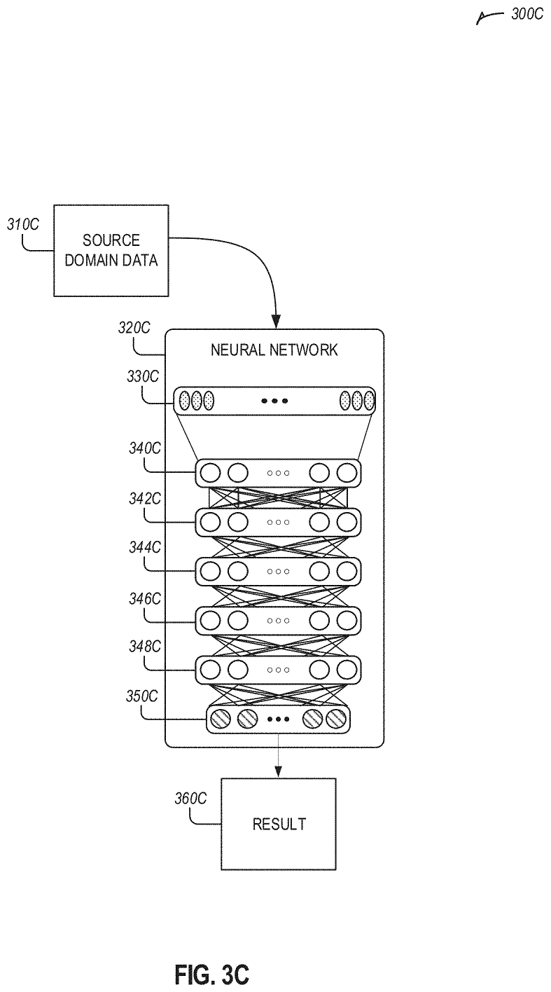

The CFPCS 110 hosts the MLSS 112 which periodically collects information from the fleet vehicles and other sources about current traffic conditions, route plan, service demand, vehicle locations, fuel level, and range estimate, etc. Based on this information, the MLSS 112 makes optimal decisions (e.g., by applying one or more machine learning (ML) techniques such as illustrated in FIG. 3B and FIG. 3C) on the locations and timings for each fleet vehicle to refuel, recharge, or park. During peak traffic hours, when the existing charging/fuel stations are crowded, or when the traffic conditions shall not allow the fleet vehicles to quickly reach the stations, the scheduling engine can take the decision to deploy EDVs at optimal locations and timings to avoid the crowded areas. Since this is a complicated problem with high dimensional optimization space, ML techniques (e.g., ML-based algorithms) may be harnessed to compute near-optimal solutions.

In urban areas, the residential, private, and enterprise buildings may have resources like parking spaces and EV charging stations that are underutilized during certain times. Making these resources available for fleet management will be beneficial for MaaS operations. The ISS 116 opens the opportunity to use these additional resources in favor of fleet management. Using the ISS 116, the residential/private owners will be able to advertise their resources based on the availability, and in-turn earn rewards from the MaaS provider.

The DLTS 114 may be used as a micro-payment framework for exchanging value for power where value can be in the form of digital currency or information assets or e-contracts. This approach allows more direct exchange interactions that circumvent complex value chains where a central entity determines the value of the various entities in the value change based on political clout, marketing influence, or other factors that may not directly relate to the value that is supplied at the point of asset exchange.

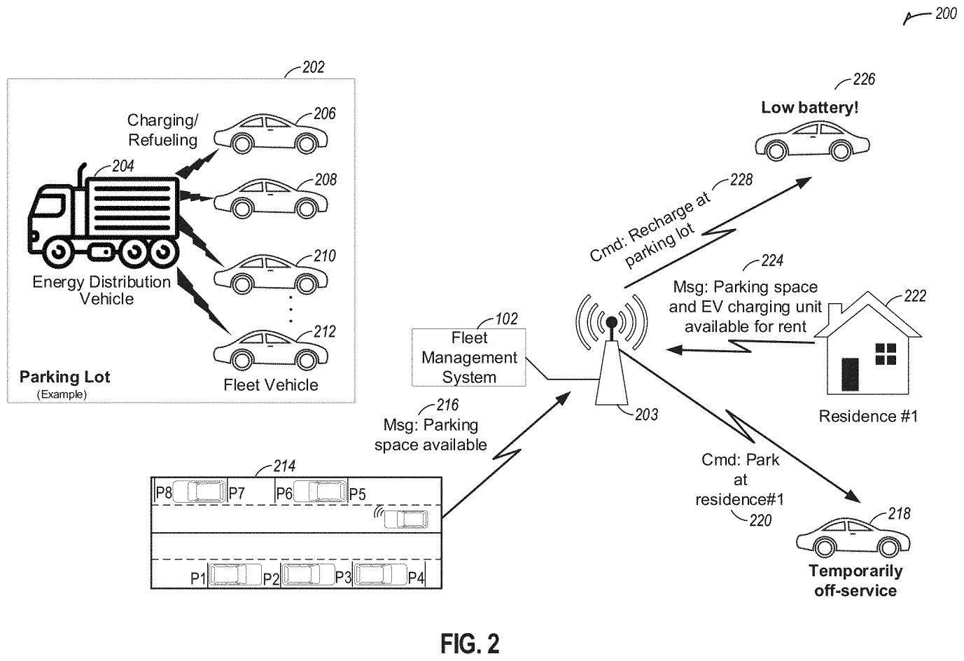

Some example use-cases of the proposed framework using the CFPCS 110 are shown in FIG. 2.

FIG. 2 illustrates example use cases 200 associated with the CFPCS, according to an example embodiment. Referring to FIG. 2, the example use cases may include the following: an EDV 204 providing a charge to EVs 206, 208, 210, . . . , 212 within a parking lot 202; a vehicle on a road 214 may detect an empty parking space P5 and may communicate a parking space availability message 216 to the fleet management system 102 via the base station 203; owner of residence 222 communicates a message 2242 base station 203 indicating parking space and EV charging unit availability for rent; and base station 203 communicates command 2282 vehicle 226 with a low battery where the command instructs the vehicle to charge at parking lot 202.

The fleet vehicles are assumed to be connected to the fleet management system 102 via wireless networks (4G, 5G, DSRC, etc.). The fleet vehicles coordinate with the fleet management by providing information such as its range estimate, route plan, on-road traffic conditions, etc. A vehicle may follow the fueling/charging/parking commands from the fleet management, and depending on the situation, the vehicle can pro-actively send a request to the system to ensure a nearby parking spot or charging station.

### MLSS (or Intelligent Scheduling Engine) to Efficiently Handle Fleet Overhead Operations

FIG. 3A illustrates a diagram 300A of a machine learning (ML) based scheduling subsystem (MLSS) 112 of the CFPCS of FIG. 1, according to an example embodiment. FIG. 3A shows an overview of the MLSS 112 with a focus on the input parameters and the output command messages. The MLSS 112 is configured to process a variety of input parameters as illustrated in FIG. 3A, and generate a series of commands at the output to optimize a set of defined objectives.

### Input Parameters

As illustrated in FIG. 3, the MLSS 112 is configured to take several input parameters from different subsystems.

Fleet vehicle information (or vehicle parameters) 308. Since the fleet vehicles are the MaaS entities that need to be scheduled for charging/fueling/parking, the MLSS 112 needs to know basic and current information about each vehicle. The fleet vehicle information 308 input parameters are periodically obtained from the individual fleet vehicle via the vehicle gateway 106. In some aspects, the fleet vehicles shall be configured to transmit the vehicle parameters periodically or on-demand through their wireless connection to the MaaS provider and the fleet management system 102. Example vehicle parameters are listed in Table 1 below.

TABLE 1

| Input Parameter | Description |
|---|---|
| Location & | The current geo-location and heading direction of |
| heading | the vehicle |
| Charge/Fuel | The current charge/fuel level in the vehicle |
| level | |
| Range estimate | Range estimate based on the historic average and |
| | current traffic conditions |
| Route plan | The current route plan of the vehicle based on the |
| | service schedule |
| On-road traffic | Traffic conditions along the route perceived from |
| conditions | the sensors in the vehicle |

Infrastructure Resource Availability 310. The MLSS 112 is configured to enable the MaaS providers to utilize the parking and EV charging resources at residences, airports, hotels, commercial and enterprise buildings, etc. The MLSS 112 can obtain the infrastructure resource availability information through an interface with the ISS 116. The availability information can be provided to the MLSS 112 on-demand, in the form of a list for a requested gets-location. Each element in the list, for example, may contain the resource information shown in Table 2 below.

TABLE 2

| Input Parameter | Description |
|---|---|
| Resource type | Parking spot, parking spot with an EV charger, |
| | etc. |
| Location | Geo-location of the resource |
| Availability | Availability timings of the resource for the |
| | next several hours |
| Preference | Preference/priority rating of the resource-based |
| score | on history, security risk, etc. |
| Attribute 1 | Additional attributes specific to the resource |
| Attribute 2 | type. For example, parking spot size, allowed |
| . | types of vehicles, EV charger type, and |
| . | wattage, etc. |
| . | |
| Attribute N | |

Demand Predictions 312. It may be preferable to avoid scheduling the fleet vehicles for overhead operations during the peak demand hours, as it is crucial to maximizing the fleet capacity during these hours. In some aspects, the MLSS 112 may obtain (e.g., on-demand) from a demand prediction module 302 information about the future demand predictions 312 within a geo-area where the relevant fleet vehicles are operating. The predictions shall contain information about expected demand in the requested geo-area during the requested times of the day/s. In some aspects, the demand prediction module 302 can be ML-based and can be part of the MLSS 112.

Points of Interests (POIs) and route planning information 314. In the context under consideration, the POIs are the relevant resources available for the fleet's usage such as parking lots and other parking spots, EV charging, and/or gas stations, etc. In some aspects, the route planning information is used by the MLSS 112 to determine the best routes and timings for the fleet vehicles to complete the overhead operations.

In some aspects, the MLSS 112 can obtain the POIs and route planning information from map cloud services 304. In some aspects, the MLSS 112 may query the map cloud services 304 (e.g., a map cloud which can be a map-generation or map-management network) by sending a set of vehicle source locations, a set of resource destination locations, and a set of timings. The map cloud may respond by providing N best routes between each vehicle and N best resource destinations, for the query timings (where N can be arbitrarily defined based on the need). While calculating the best routes, the map cloud may also consider the traffic predictions for the given timings. The route planning information responded by the map cloud is used as the input parameter by the MLSS 112.

Government Rules and Regulations 316 may be obtained from a local regulations service 306 (e.g., a network providing access to the government rules and regulations 316). The sharing of residential parking spaces for fleet management might cause additional traffic in residential areas. Additionally, local governments may have certain restrictions. For example, traffic limits in residential areas to avoid congestions, designated areas for fueling of vehicles, etc. The MLSS 112 can be configured with mechanisms to cooperate with the city authorities and implement their rules.

Additionally, Government Rules and Regulations may include taxation rules such as energy use tax, highway use and maintenance tax, vehicle property tax, sales tax (on the sale of energy) or e-services provided via the MaaS infrastructure, etc. The MLSS 112 may provide mechanisms for the collection of taxes that leverages the micro-payment capabilities described herein.

### Optimization Algorithm

The MLSS 112 can be configured to use one or more ML techniques (including optimization algorithms) to solve an optimization problem with a variety of input parameters as described above. As the number of active fleet vehicles increases, the optimization problem becomes more complex and difficult to be handled by deterministic algorithms. Hence, the algorithm may make use of ML techniques to calculate optimum/near-optimum solutions. The present disclosure describes the optimization problem on a high level with informal definitions of the optimization criteria and related constraints.

Objective. The objective or goal of the optimization problem can be such that it maximizes the overall efficiency and economy of the MaaS system. In some aspects, a multi-objective optimization problem can be considered, and it can be slightly different between charging, refueling, and parking overheads. Some of the main objectives (or optimization criteria) that can be considered while designing the MLSS 112 are described below.

An example objective can include minimizing the expected travel time to the resource (parking spot, or charging/gas station), and the travel time to the next service destination (if known). Minimizing the travel time will make sure that the fleet vehicle shall cause as little as possible traffic footprint due to the overhead operations.

In the case of charging/fueling, an example objective includes minimizing the expected standby time which includes waiting time (at charging/gas station) and fulfillment time. In the case of charging, the fulfillment time can vary widely depending on the wattage of the charger.

An example objective includes minimizing the overall cost of the overhead operation. It includes the direct costs incurred for charging, fueling, or parking and indirect costs like the cost of traveling to the resource destination.

An example objective includes maximizing the availability of the fleet and distributed across the service area in proportion to the distribution of the demand prediction.

In some aspects, the MLSS 112 can also consider distributing the routes of the fleet vehicles across different areas to avoid congestions. For example, if more fleet vehicles are scheduled to visit the same refueling station at the same time, then most probably there will be congestion along the route and at the station. Hence it can be avoided.

Since some trade-offs exist between the objectives, the final objective function may be obtained by a weighted average of the individual objectives. In some aspects, the weights are dynamic and depend on different factors. Some examples are as follows. When higher demand is predicted in near future, a higher weight may be used for maximizing the availability of the fleet, minimizing expected travel time and stand-by time; while smaller weights for minimizing the overall cost. In another example of overnight parking of vehicles, large weight may be placed for minimizing the overall cost of the overhead operation, while placing small weights for the other objectives.

Optimization Parameters and Constraints. The optimization parameters are the choices that the MLSS 112 needs to select intelligently to achieve the above-mentioned objectives. Each optimization parameter may affect one or more objectives. Below are the main parameters that the MLSS 112 can be configured to optimize (e.g., during ML model training as discussed in connection with FIG. 3A and FIG. 3B):

(a) Timings of overhead operations: This parameter affects all the objectives listed above. There can be certain constraints in choosing this parameter for each fleet vehicle. For example, the latest time limit may be governed by factors such as the remaining charge/fuel in the vehicle, distance to the nearest available resource, etc.

(b) Charging/fueling/parking resources: This parameter belongs to the set of resources available in the service area which includes dedicated MaaS facilities, public resources such as parking lots/refueling stations, and the residential/enterprise resources available via the online sharing platform (e.g., the ISS). The values of the objectives will vary for different resources depending on the attributes of the resources such as location, price/cost, fulfillment time, etc. There may be some constraints to choosing the resources for the fleet vehicles due to the government regulations, or due to the reservation limitations.

(c) Number of EDVs to dispatch: During certain times when there is a lack of (easily) available resources, during peak traffic hours for example, then achieving required objective values may be difficult. In such cases, deploying EDVs to charge/fuel the fleet vehicles may significantly improve the objective values. The effect of this parameter on the objectives may be determined by considering other related parameters such as the EDV target locations, timings, etc.

Output Control Commands (of the MLSS 112). The MLSS 112 periodically solves the optimization problem as described above and generates outputs 318, 320, 322, and 324 as discussed herein. For every iteration, based on the resulting solution, the MLSS 112 generates control commands at specific timings. These control commands are sent to different subsystems of the MaaS provider to execute the overhead operations. The main commands generated by the scheduling engine are listed below.

Vehicle commands 322 which are communicated to the vehicle gateway 106. These control commands are specific to the individual fleet vehicles and are sent via the vehicle gateway 106, which are then sent through the wireless networks. These commands may contain instructions for the vehicles to charge/refuel/park by visiting particular locations.

EDV dispatch commands 324 communicated to the vehicle dispatch subsystem 104. These control commands are sent to the vehicle dispatch subsystem 104 to dispatch EDVs at target locations. It also contains additional instructions such as the fuel/charge capacity to carry, the IDs of the fleet vehicles to charge/refuel, etc.

Reservation commands 320 (sent to the ISS 116) and reservation payments 318 (sent to the DLTS 114). These commands are used for the reservation of required resources in the online sharing platform (e.g., ISS 116). The payments needed to reserve the resources are sent through the payment system of the DLTS 114.

### Online Marketplace Sharing Platform (ISS 116)

The ISS 116 allows the MaaS fleet management system 102 to harness the resources available at residential and enterprise infrastructures. In sonic aspects, the ISS 116 can include an online marketplace sharing platform that can be used in the fleet management system 102 through which property owners can list their private parking spaces and EV chargers (if available). In some aspects, the online sharing platform of the ISS 116 can be integrated with the MLSS 112 as part of the CFPCS 110 (as illustrated in FIG. 1), which then becomes a part of the optimization process (e.g., ML-based training and model generation for the MLSS 112, as discussed in connection with FIG. 3A and FIG. 3B). With this integrated setup, the overhead processes in the fleet management can be optimized to a greater extent, which is not feasible with online sharing platforms alone.

Example requirements of the ISS 116 for optimization, and its interfaces with the MaaS fleet management system 102, are described herein. In some aspects, it can be assumed that the ISS 116 maybe be hosted within the MaaS provider system as part of the CFPCS 110, or may also be hosted by external cloud services (e.g., as part of an external network that is separate from the fleet management system 102). Below are some features of the ISS 116 that can be integrated with the scheduling engine:

(a) The ISS 116 is configured to implement reliable and secure services that would allow legitimate residential and enterprise owners to register and list their resources (parking spaces and EV chargers) on the platform. The ISS 116 can also include adequate mechanisms to collect and verify the necessary details (location, size, type, etc.) of the resources accurately from the users.

(b) In some aspects, the ISS 116 is configured to allow the owners to set prices of the resources (e.g., dynamically) and can be configured to provide services for the registered users to reserve the resources.

(c) In some aspects. the ISS 116 is configured to allow the users to pay for the reservations via the DLTS 114.

(d) In some aspects, the ISS 116 is configured to provide services for on-demand queries about the availability of resources within the requested geo-area. It should also provide services through which the scheduling algorithm can fetch detailed information about the resources of interest.

### Micro-Payments System (e.g., DLTS 114)

The DLTS 114 is configured to extend to multiple points of service or information exchange interfaces in the MaaS network 100. Each resource that is available to be scheduled, exchanged, or bartered is equipped with a micro-payment exchange interface, e-wallet, and access to transaction clearing nodes. In the context of refueling/recharging, in some embodiments, the energy provider may supply m Watts of energy in exchange for n micro-payment tokens. The resource that needs recharging/refueling receives payment for services or value it creates in micro-payment tokens which accumulate in its e-wallet (and which later can be used to purchase energy to recharge/refuel).

In some aspects, the micro-payments in the DLTS 114 use a decentralized clearinghouse approach such as Distributed Ledger Technology (DLT) to handle transaction clearing. The DLT nodes can be hosted virtually anywhere in the MaaS network 100, including integration into radio access network (RAN) infrastructure such as radio towers, base stations, low Earth orbit (LEO) satellites, or can be integrated into MaaS edge nodes (light poles, traffic signals, cameras, mobile devices, IoT sensors, or other vehicle-to-everything (V2X) devices, etc.

Clean energy discounts and subsidies could be more easily tracked by the DLTS 114 where a clean solar charging station could attest to the type of energy creation in an e-contract for supplying energy. A clean energy subsidy may be contributed to the transaction such that the assessed value per watt is lower resulting in fewer micro-payment tokens needing to be exchanged in return. For example, the EV may have received Uber-like compensation from ridesharing in e-currency such as Ethereum. Rather than converting Ether to Euros, the charging facility can only accept payment in Dollars. Unnecessary conversion loss can be avoided by exchanging in a variety of currencies including information assets in the form of e-contracts.

In some aspects, the DLTS 114 includes a micro-payment module (MPM) which can consist of a MaaS node used for efficient processing of micro-payments in exchange for processing, The MPM may be instrumented with a variety of internal sensors/meters for determining the amount of computing resource used to perform a unit of work (UoW). The UoWs consumed to perform a MaaS operation/workload is tallied and used to charge a tenant's e-wallet as needed/authorized. The MPM may also pay for resources in a ‘pay-per-use’ model to account for power, cooling, tamper-resistance, and other costs associated with hosting a MaaS service on a MaaS Node. An e-contract may be created to guarantee payment for any MaaS Node micro-transaction and to ensure ACID (atotnicity, consistency, isolation, durability) properties, no double-spend, and so forth.

FIG. 3B is a block diagram 300B illustrating the training of deep learning (DL) model 310B used by the MLSS of FIG. 3A, according to an example embodiment. In some example embodiments, machine-learning programs (MLP's), including deep learning programs, also collectively referred to as machine-learning algorithms or tools or techniques, are utilized to perform operations associated with correlating data or other artificial intelligence (AI)-based functions in connection with functions performed by the MLSS 112 and described herein.

As illustrated in FIG. 3B, deep learning model training 308B is performed within the deep learning architecture (DLA) 306B based on training data 302B (which can include features). During the deep learning model training 308B, features from the training data 302B can be assessed for purposes of further training of the DL model. The DL model training 308B results in a trained DL model 310B. The trained DL model 310B can include one or more classifiers 312B that can be used to provide DL assessments 316B (e.g., assessments performed in connection with functionalities of the MLSS 112) based on new data 314B (which can be obtained by the MLSS 112 from one or more other subsystems in the fleet management system 102).

In an example embodiment, the DLA 306B and the deep learning model training 308B is performed within the MLSS 112. The trained model 310B is also included as part of the MLSS 112. In other aspects, the training and model storage can be provided in a remote network, which the MLSS 112 can access on demand.

In some aspects, the training data 302B can include input data 303B and output data 305B which can be configured based on the optimization functions of the MLSS 112 discussed hereinabove. The input data 303B and the output data 305B are used during the DL model training 308B to train the DL model 310B. In this regard, the trained DL model 310B receives new data 314B, extracts features based on the data, and performs an event determination using the new data 314B.

Deep learning is part of machine learning, a field of study that gives computers the ability to learn without being explicitly programmed. Machine learning explores the study and construction of algorithms, also referred to herein as tools, that may learn from existing data, may correlate data, and may make predictions about new data. Such machine learning tools operate by building a model from example training data (e.g., the training data 302B) to make data-driven predictions or decisions expressed as outputs or assessments 316B. Although example embodiments are presented with respect to a few machine-learning tools (e.g., a deep learning architecture), the principles presented herein may be applied to other machine learning tools.

In some example embodiments, different machine learning tools may be used. For example, Logistic Regression, Naive-Bayes, Random Forest, neural networks, matrix factorization, and Support Vector Machines tools may he used during the deep learning model training 308B (e.g., for correlating the training data 302B).

Two common types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number). In some embodiments, the DLA 306B can be configured to use machine learning algorithms that utilize the training data 302B to find correlations among identified features that affect the outcome.

The machine learning algorithms utilize features from the training data 302B for analyzing the new data 314B to generate the assessments 316B. The features include individual measurable properties of a phenomenon being observed and used for training the machine learning model. The concept of a feature is related to that of an explanatory variable used in statistical techniques such as linear regression. Choosing informative, discriminating, and independent features are important for the effective operation of the MLP in pattern recognition, classification, and regression. Features may be of different types, such as numeric features, strings, and graphs. In some aspects, training data can be of different types, with the features being numeric for use by a computing device.

In some aspects, the features used during the DL model training 308B can include the input data 303B, the output data 305B, as well as one or more of the following: sensor data from a plurality of sensors (e.g., audio, motion, GPS, image sensors); actuator event data from a plurality of actuators (e.g., wireless switches or other actuators); external information from a plurality of external sources; timer data associated with the sensor state data (e.g., time sensor data is obtained), the actuator event data, or the external information source data; user communications information; user data; user behavior data, and so forth.

The machine learning algorithms utilize the training data 302B to find correlations among the identified features that affect the outcome of assessments 316B. With the training data 302B (which can include identified features), the DL model is trained using the DL model training 308B within the 306B. The result of the training is the trained DL model 310B (e.g., the neural network 320C of FIG. 3C). When the DL model 310B is used to perform an assessment, new data 314B is provided as an input to the trained DL model 310B, and the DL model 310B generates the assessments 316B as an output. For example. the DIA 306B can be deployed within the MLSS 112 to perform ML techniques as discussed herein.

FIG. 3C illustrates a diagram 300C of the structure of a neural network which can be used by the MLSS of FIG. 3A using the DLA 306B of FIG. 3B, according to an embodiment. The neural network 320C takes source domain data 310C (e.g., data as provided by the MLSS 112 for performing one or more ML-based techniques) as input, processes the source domain data 310C using the input layer 330C; the intermediate, hidden layers 340C, 342C, 3440. 346C, AND 348C; and the output layer 350C to generate a result 360C.

Each of the layers 330C-350C comprises one or more nodes (or “neurons”). The nodes of the neural network 320C are shown as circles or ovals in FIG. 3C. Each node takes one or more input values, processes the input values using zero or more internal variables, and generates one or more output values. The inputs to the input layer 330C are values from the source domain data 310C. The output of the output layer 350C is the result 360C. The intermediate layers 340C-348C are referred to as “hidden” because they do not interact directly with either the input or the output, and are completely internal to the neural network 320C. Though five hidden layers are shown in FIG. 3C, more or fewer hidden layers may be used.

A model may be run against a training dataset for several epochs (e.g., iterations), in which the training dataset is repeatedly fed into the model to refine its results. For example, in a supervised learning phase, a model is developed to predict the output for a given set of inputs and is evaluated over several epochs to more reliably provide the output that is specified as corresponding to the given input for the greatest number of inputs for the training dataset. In another example, for an unsupervised learning phase, a model is developed to cluster the dataset into n groups and is evaluated over several epochs as to how consistently it places a given input into a given group and how reliably it produces the n desired clusters across each epoch.

Once an epoch is run, the model is evaluated and the values of its variables are adjusted to attempt to better refine the model iteratively. In various aspects, the evaluations are biased against false negatives, biased against false positives, or evenly biased with respect to the overall accuracy of the model. The values may be adjusted in several ways depending on the machine learning technique used. For example, in a genetic or evolutionary algorithm, the values for the models that are most successful in predicting the desired outputs are used to develop values for models to use during the subsequent epoch, which may include random variation/mutation to provide additional data points. One of ordinary skill in the art will be familiar with several other machine learning algorithms that may be applied with the present disclosure, including linear regression, random forests, decision tree learning, neural networks, deep neural networks, etc.

Each model develops a rule or algorithm over several epochs by varying the values of one or more variables affecting the inputs to more closely map to the desired result, but as the training dataset may be varied, and is preferably very large, perfect accuracy and precision may not be achievable. A number of epochs that make up a learning phase, therefore, may be set as a given number of trials or a fixed time/computing budget or may be terminated before that number/budget is reached when the accuracy of a given model is high enough or low enough or an accuracy plateau has been reached. For example, if the training phase is designed to run n epochs and produce a model with at least 95% accuracy, and such a model is produced before the nth epoch, the learning phase may end early and use the produced model satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs—having reached a performance plateau—the learning phase for the given model may terminate before the epoch number/computing budget is reached.

Once the learning phase is complete, the models are finalized. In some example embodiments, models that are finalized are evaluated against testing criteria, in a first example, a testing dataset that includes known outputs for its inputs is fed into the finalized models to determine the accuracy of the model in handling data that it has not been trained on. In a second example, a false positive rate or false-negative rate may be used to evaluate the models after finalization. In a third example, a delineation between data clusterings is used to select a model that produces the clearest bounds for its clusters of data.

The neural network 320C may be a deep learning neural network, a deep convolutional neural network, a recurrent neural network, or another type of neural network. A neuron is an architectural element used in data processing and artificial intelligence, particularly machine learning, that includes a memory that may determine when to “remember” and when to “forget” values held in that memory-based on the weights of inputs provided to the given neuron. An example type of neuron in the neural network 320C is a Long Short Term Memory (LSTM) node. Each of the neurons used herein is configured to accept a predefined number of inputs from other neurons in the network to provide relational and sub-relational outputs for the content of the frames being analyzed. Individual neurons may be chained together and/or organized into tree structures in various configurations of neural networks to provide interactions and relationship learning modeling for how each of the frames in an utterance is related to one another.

For example, an LSTM serving as a neuron includes several gates to handle input vectors (e.g., time-series data), a memory cell, and an output vector. The input gate and output gate control the information flowing into and out of the memory cell, respectively, whereas forge gates optionally remove information from the memory cell based on the inputs from linked cells earlier in the neural network. Weights and bias vectors for the various gates are adjusted over the course of a training phase, and once the training phase is complete, those weights and biases are finalized for normal operation. One of skill in the art will appreciate that neurons and neural networks may be constructed programmatically (e.g., via software instructions) or via specialized hardware linking each neuron to form the neural network.

A neural network sometimes referred to as an artificial neural network, is a computing system based on consideration of biological neural networks of animal brains. Such systems progressively improve performance, which is referred to as learning, to perform tasks, typically without task-specific programming. For example, in image recognition, a neural network may be taught to identify images that contain an object by analyzing example images that have been tagged with a name for the object and, having learned the object and name, may use the analytic results to identify the object in untagged images. A neural network is based on a collection of connected units called neurons, where each connection, called a synapse, between neurons, can transmit a unidirectional signal with an activating strength that varies with the strength of the connection. The receiving neuron can activate and propagate a signal to downstream neurons connected to it, typically based on whether the combined incoming signals, which are from potentially many transmitting neurons, are of sufficient strength, where strength is a parameter.

A deep neural network (DNN) is a stacked neural network, which is composed of multiple layers. The layers are composed of nodes, which are locations where computation occurs, loosely patterned on a neuron in the human brain, which fires when it encounters sufficient stimuli. A node combines input from the data with a set of coefficients, or weights, that either amplify or dampen that input, which assigns significance to inputs for the task the algorithm is trying to learn. These input-weight products are summed, and the sum is passed through what is called a node's activation function, to determine whether and to what extent that signal progresses further through the network to affect the outcome. A DNN uses a cascade of many layers of non-linear processing units for feature extraction and transformation. Each successive layer uses the output from the previous layer as input. Higher-level features are derived from lower-level features to form a hierarchical representation. The layers following the input layer may be convolution layers that produce feature maps that are filtering results of the inputs and are used by the next convolution layer.

In the training of a DNN architecture, a regression, which is structured as a set of statistical processes for estimating the relationships among variables, can include minimization of a cost function. The cost function may be implemented as a function to return a number representing how well the neural network performed in mapping training examples to correct output. In training, if the cost function value is not within a pre-determined range, based on the known training images, backpropagation is used, where backpropagation is a common method of training artificial neural networks that are used with an optimization method such as a stochastic gradient descent (SGD) method.

Use of backpropagation can include propagation and weight update. When an input is presented to the neural network, it is propagated forward through the neural network, layer by layer, until it reaches the output layer. The output of the neural network is then compared to the desired output, using the cost function, and an error value is calculated for each of the nodes in the output layer. The error values are propagated backwards, starting from the output, until each node has an associated error value which roughly represents its contribution to the original output. Backpropagation can use these error values to calculate the gradient of the cost function with respect to the weights in the neural network. The calculated gradient is fed to the selected optimization method to update the weights to attempt to minimize the cost function.

In some example embodiments, the structure of each layer is predefined. For example, a convolution layer may contain small convolution kernels and their respective convolution parameters, and a summation layer may calculate the sum, or the weighted sum, of two or more values. Training assists in defining the weight coefficients for the summation.

One way to improve the performance of DNNs is to identify newer structures for the feature-extraction layers, and another way is by improving the way the parameters are identified at the different layers for accomplishing the desired task. For a given neural network, there may be millions of parameters to be optimized. Trying to optimize all these parameters from scratch may take hours, days, or even weeks, depending on the number of computing resources available and the amount of data in the training set.

### Fleet Management Solution for QoS Optimization via Predictive, Recharging/Refueling

In some aspects, fleets of autonomous vehicles (AVs) for ride-hailing services can navigate smart cities and conglomerate in hotspots. The location of the hotspots can continuously change depending on the time of the day, day of the week, season, etc. At some point in their daily routine, several vehicles in the fleet will have to recharge. Since hotspots change over time, it is not cost-effective for the fleet management to have fixed locations where charging could happen. In addition to avoiding this inefficiency, cities of the future should avoid increasing visual pollution by having real state used for fixed charging stations. Fixed charging stations result in suboptimal trips and increased downtime for the on-demand fleet. Mobile charging stations alone do not solve the problem, and they might aggravate it.

Currently, the majority of existing charging solutions are based on fixed infrastructure, which presents several challenges described herein. Fleet vehicles, whether manually driven or automated, have to drive to the public infrastructure charging/refueling locations, and the period, while those vehicles are driving to (and recharging/refueling), is downtime affecting the fleet owner's revenue.

The state of mobile charging infrastructure is still in the early stages. In some aspects, vehicles can be deployed to charge other vehicles. For instance, the Nation-E's Angel Car is a mobile charging station meant to support stranded EVs. However, currently, there is no complete solution that efficiently manages the logic for the deployment of mobile charging infrastructure to minimize the fleet's downtime.

In some aspects, a cell type representation may be used to describe coverage areas in the map for the vehicles and define corridors between cells to determine potential service time when requests require moving from one cell to another. The cells, however, are fixed and do not consider the dynamic changes of hotspots in cities, nor the current charge/fuel state of the fleet.

When the charging infrastructure is fixed, vehicles in the fleet may have to traverse long distances to be recharged, increasing their downtime. Additionally, mobile charging stations by themselves do not solve the problem of minimizing AVS downtime. The disclosed techniques may be used as a complete solution that uses mobile charging stations but also ML-based techniques to efficiently support fleets of AVs. More specifically, the proposed techniques may be used to maximize the performance of electric (or fuel) fleets. It creates a “dynamic service” real-time map based on prediction usage demand and existing fleet resources range and anticipates the need for recharging in a fleet of AVs to maintain/maximize Quality of Service (QoS) by deploying mobile charging stations (also referred to as EDVs) and determine how much each vehicle must be recharged to support the demand in the determined areas. The disclosed techniques can be used (e.g., by the MLSS 112) to manage the fleet more efficiently and reduce the downtime of individual vehicles. The disclosed techniques present the following additional advantages. The disclosed techniques anticipate the need for vehicles to recharge/refuel and deploys the mobile solution to a convenient location near them. The disclosed techniques can be used by the MLSS 112 (or other subsystems within the fleet management system 102) to bring vehicles back to partial or full charge capacity in a place close to their last ride, hence, reducing their downtime. The disclosed techniques are used to reduce fixed charging stations' visual pollution in the cities of the future. The disclosed techniques are used to remove the dependency of the fleet in public charging stations at fixed locations, and to reduce the trips of multiple AVs to a fixed charging station that might be far from the AVs.

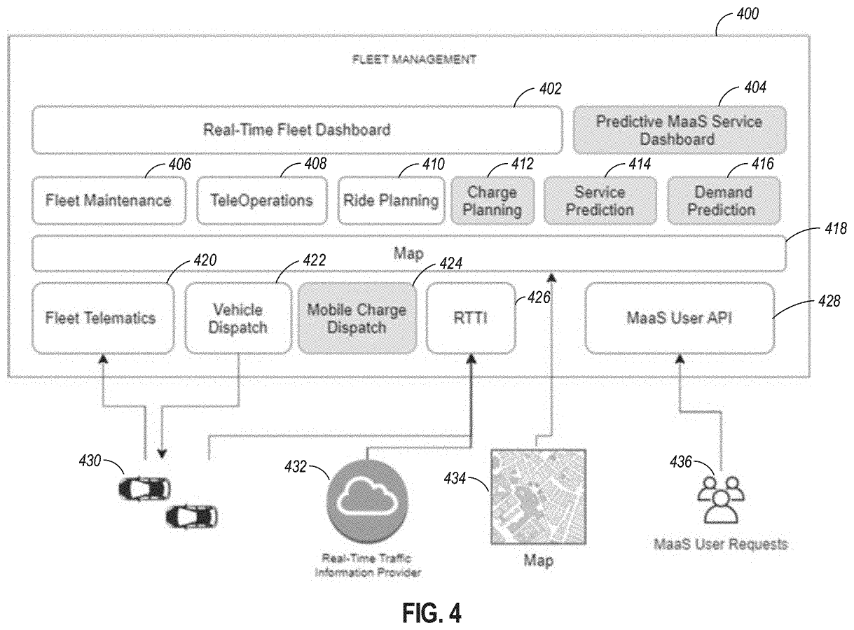

The disclosed techniques can be used for performing fleet management optimization associated with a defined quality of service through predictive demand and service monitoring and deployment of mobile charging units to strategic locations in the supported MaaS area. FIG. 4 illustrates the building blocks for a MaaS fleet management system using the disclosed techniques.

FIG. 4 illustrates a system overview for another example of a fleet management system 400 with quality of service (QoS) optimization via predictive recharging/refueling, according to an example embodiment. The fleet management system 400 can be the same as the fleet management system 102 of FIG. 1, with FIG. 4 providing a different network perspective of the fleet management system.

The fleet management system 400 includes a real-time fleet dashboard 402, a predictive MaaS service dashboard 404, fleet maintenance subsystem 406, operations subsystem 408, ride planning subsystem 410, charge planning subsystem 412, service prediction subsystem 414, demand prediction subsystem 416, map information 418, fleet telematics subsystem 420, vehicle dispatch subsystem 422, mobile charging dispatch subsystem 424, real-time traffic information (RTTI) 426, and MaaS user application programming interface (API) 428.

The fleet telematics subsystem 420 and the vehicle dispatch subsystem 422 may communicate with the fleet of vehicles 430. The RTTI 426 can be obtained from the fleet of vehicles 430 or a real-time traffic information provider 432. The map information 418 is obtained from a map source 434. The MaaS user API 428 is configured to handle MaaS user requests 436 associated. with services provided by the fleet management system 400. The demand prediction subsystem 416 can be configured to access service requests and historical service requests data. The service prediction subsystem 414 is configured to predict where services will be needed, including several vehicles, vehicle capacity, etc.

In an example embodiment, the disclosed techniques can be associated with functionalities provided by the predictive MaaS service dashboard 404, the charge planning subsystem 412, the service prediction subsystem 414, the demand prediction subsystem 416, and the mobile charging dispatch subsystem 424. In an example embodiment, the disclosed techniques can perform prediction or planning functionalities which can be performed using the disclosed ML-based techniques. In this regard, disclosed prediction or planning functionalities of the fleet management system 400 can be performed by the MLSS 112 and its ML-based functionalities.

The following disclosure is associated with transitioning from static demand maps to real-time dynamic fleet monitoring maps with charge and demand prediction.

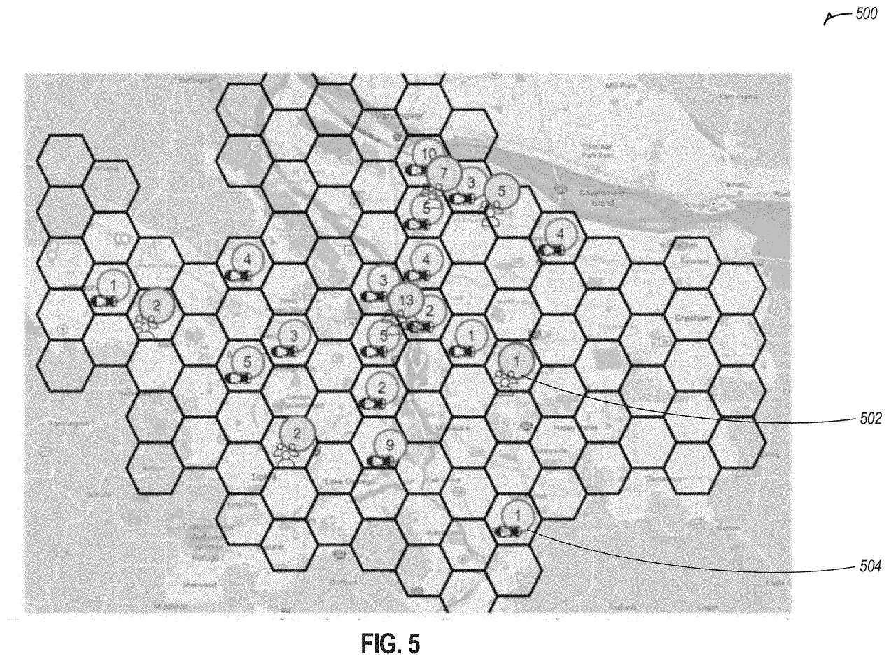

FIG. 5 illustrates a map representation 500 of the Portland, Oregon metropolitan area with service zones represented as hexagonal grids and existing demand/fleet resources represented with icons, according to an example embodiment. FIG. 5 illustrates that the presence of fleet vehicles may be monitored in the coverage area, e.g., Portland metropolitan area. In some aspects, the coverage area is divided based on service needs and time to service, and the existence of fleet vehicles and customer demands may be monitored. For example icons 502 represent incoming service requests and icons 504 represent the availability of vehicles in an area. In some aspects, random time variable and time-dependent and minimum cost path models for routing fleet vehicles.

However, the above approaches do not include functionalities for representing the ability of the fleet to service these demands. Furthermore, taking into account vehicle charge/refueling needs the real-time location of these vehicles might not reflect the ability of the fleet to support the current or predicted demand.

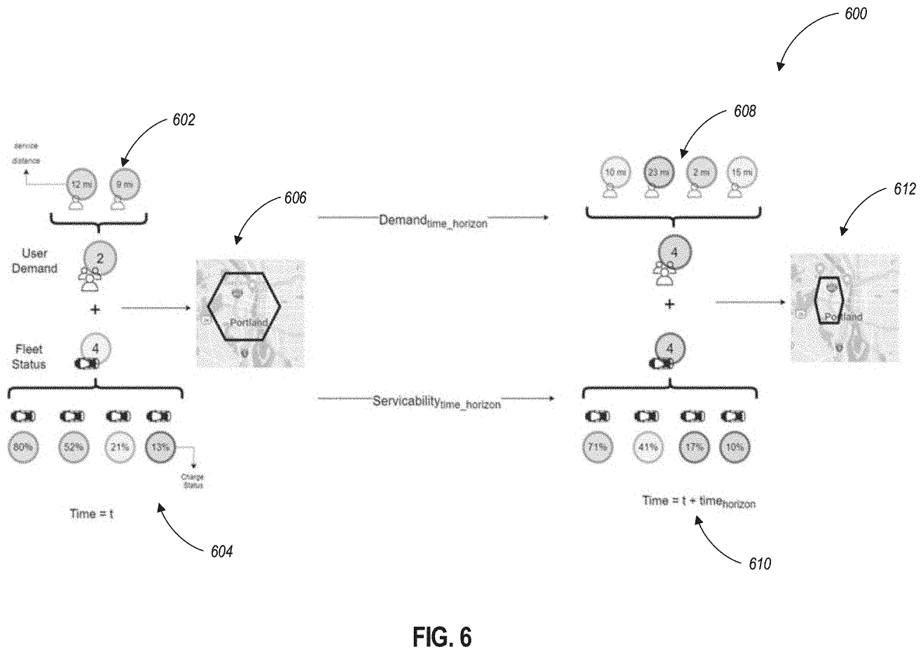

Vehicle telematics allows today to monitor fuel/battery status remotely, and this information can be combined with predicted user demands to determine future on-demand service needs. Such information may be used in a combined demand prediction module with vehicle fleet resource use prediction models to create dynamic boundary estimation of service cells in defined time horizon, as illustrated in FIG. 6.

FIG. 6 illustrates diagram 600 of dynamic service area boundary calculations based on demand and serviceability prediction on a time horizon, according to an example embodiment. Referring to FIG. 6, user demand information 602 can be combined with fleet status information 604 to generate a boundary 606 associated with the user demand and fleet status. After some time (e.g., time_horizon), the user demand has changed to user demand 608, and the fleet status has changed to fleet status 610. The updated user demand 608 and fleet status 610 used to update the boundary to boundary 612 representative of the new demand and fleet status.

The user demand prediction model is trained with historic data from user demand collected through the MaaS application/calls from the API. This model includes location when initiating the MaaS transport request as well as the intended destination. Contextual data during the request is also collected as well as user profile data.

In some aspects, the fleet serviceability prediction model is trained from historic data to estimate fuel/battery consumption, receiving as input also vehicle characteristics, average consumption, and traffic information as well as in-vehicle service use that might affect range (e.g., use of AC/heating).

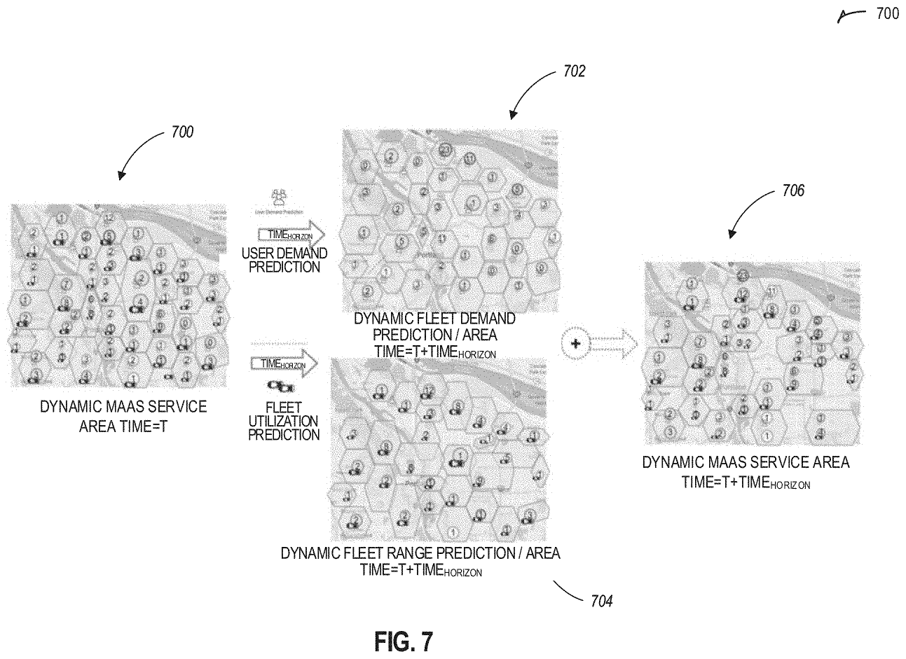

The resulting model output can be combined to calculate the MaaS coverage area depicted as service reachability sets which can serve to identify service need hotspots taking into consideration the deployment of adjacent cell vehicles to cover service needs within a time horizon. The resulting map is a dynamic MaaS Service Area prediction with variable size cells which is illustrated in FIG. 7.

FIG. 7 illustrates a dynamic MaaS service area map 700 combining user demand predictions with fleet range predictions, according to an example embodiment. FIG. 7, the dynamic MaaS service area map 700 at time T is updated (after elapsed time TimeHorizon) with user demand predictions to obtain dynamic fleet demand prediction per area 702 (for time T+TimeHorizon), and with fleet utilization prediction to obtain dynamic fleet arrange prediction per area 704. The dynamic fleet demand prediction and the dynamic fleet range prediction are combined to obtain a dynamic MaaS service area 706 associated with time T+TimeHorizon.

As a result of the above functionality, the fleet operator of the fleet management system can monitor demand and available resources as as predict cases in which hotspots in user demand will converge with low availability of fleet resources driving low coverage capability and, therefore, a reduction of the quality of MaaS service for the targeted area.

This task may be solved by deploying more fleet vehicles than demand. However, such a solution may be ineffective and wasteful of resources. On the other hand, downtime on resources due to refueling/recharging is not optimal. In this regard, a mobile charging station may be used with appropriate monitoring, which station is capable of maintaining the targeted quality of service.

The following disclosure is associated with fleet management of mobile charging stations for MaaS QoS guarantees.

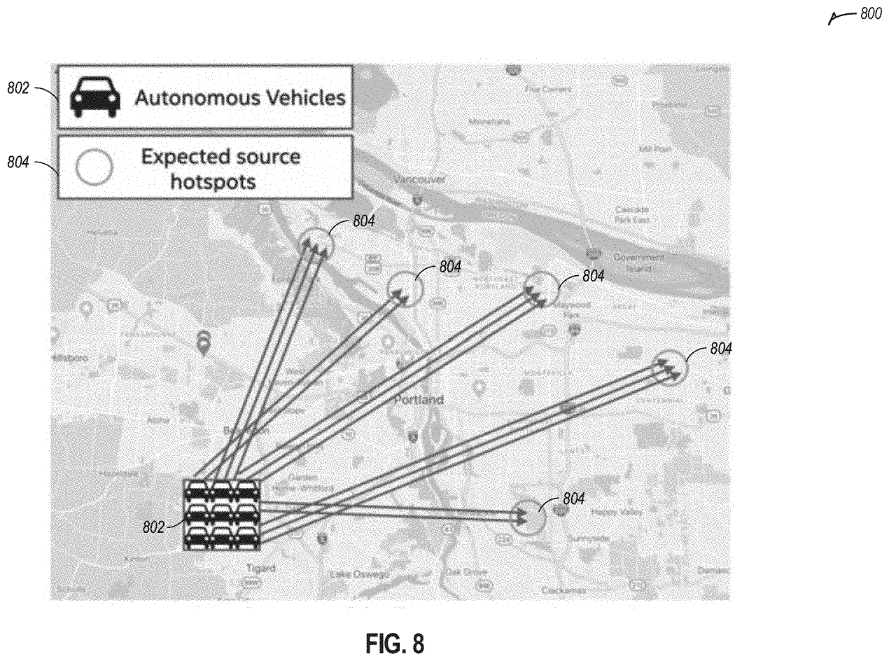

FIG. 8 illustrates an initial deployment 800 of a fleet of vehicles to expected source hotspots, according to an example embodiment. Referring to FIG. 8, the illustrated map can be updated with the location of autonomous vehicles 802 and expected source hotspots 804.

In same aspects, ride-hailing (or other similar services), AVs may be deployed in the smart city. Initial deployment can be from headquarters to random locations or to expected source hotspots in the smart city (as illustrated in FIG. 8). The latter deployment is a mark of an efficient fleet and it is what the solution does. That is, it uses the user demand prediction model described above to distribute the fleet in the smart city.

In some embodiments, at time t_{expCh}, when several AVs in the fleet are expected to be close to crossing a threshold in their current charging levels, the innovation kicks in and uses as input a set of expected positions of AVs in the fleet when the mobile charges will be approaching the meeting point. The fleet manager or the administrator of the solution oversees the behavior of the innovation and its proposed actions.

In additional embodiments, estimating the maximum time needed for deployment of mobile charging stations can be performed as follows. As a worst-case reference, the disclosed functionalities use the position P_{ref} to the furthest destination of any AV, from any (in case there is more than one) mobile charging stations headquarters to the AV in the set of AVs with a charge below α×chargeₜₕ, s.t. α>1 and α×chargeₜₕ is less than the full charge of the AV, where chargeₜₕ is the threshold that determines that an AV will need to recharge, and a is a coefficient greater than 1 to relax the threshold and allow the solution with some time to configure the deployment of the mobile charging component. The following equations may also be used:

$$R ( {MHQ}_{i} , {P}_{r e f} ) = {\sum }_{k = 1}^{n} {d}_{k} and {R}_{ma x} = {max}_{i} R ( {MHQ}_{i} , {P}_{ref} ) ,$$

where R computes the sum of the k way points, dₖ, to reach out a destination. MHQ is the starting location for a mobile charging station to the furthest destination of any AV in the fleet, and Rₘₐₓ is the maximum distance, i.e., the sum of waypoints dₖ, that a mobile station has to traverse to reach the furthest expected AV's position from its HQ. In the above equations, it may be assumed that all the mobile charging stations will be deployed from a centralized headquarter, but the innovation can accommodate distributed source locations for the mobile charging stations.

In some aspects, the disclosed techniques can be used to construct a set, [symbol] , of all the estimated AVs positions that will have a charge below α×chargeₜₕ in the time horizon. That is, this set contains the expected position for each AV that might need a charge at a time equal to the current time plus T(Rₘₐₓ), the maximum time that a mobile charging station will require to reach the approximated furthest charging location.

In an example embodiment, the disclosed techniques can be used. to detect k clusters of expected positions of AVᵢ ∈ [symbol] (AVs that are expected to have a charge below the threshold chargeₜₕ once the mobile charging stations have been deployed. Variable k is the number of mobile charging stations available for the fleet. If a cluster contains less than min_size AVs that will need recharging, these AVs are assigned to a neighboring cluster, and the mobile infrastructure that was supposed to service this cluster is reassigned to the cluster that has the highest ratio between AVs/charging stations assigned.

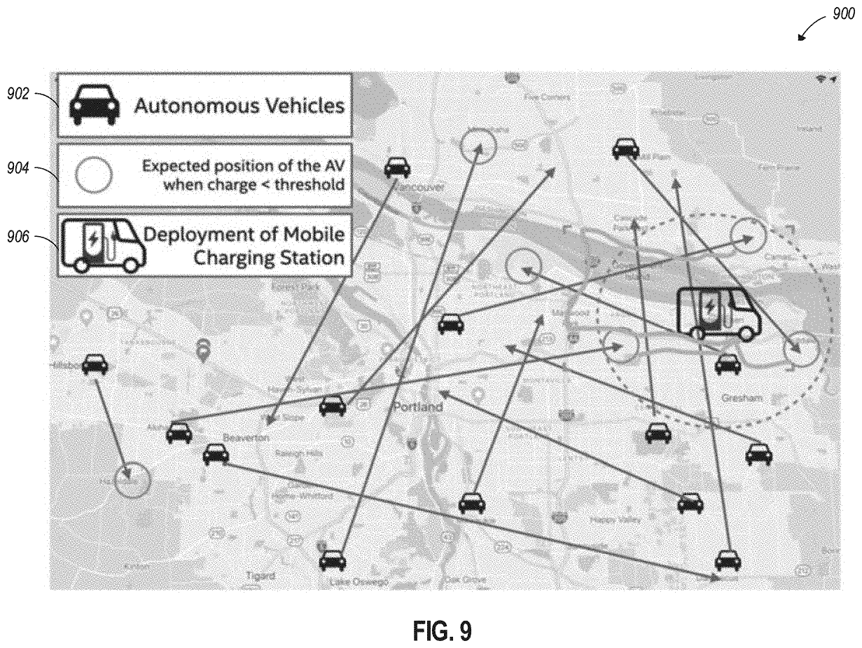

To form the clusters, the disclosed techniques can avoid using the Euclidean distance between the expected position of the AVs when approaching the need for recharging and current centroids at iteration i of the clustering algorithm. The distance between the two points doesn't reflect the time and complications that the AV might have to traverse streets with traffic to arrive at the mobile charging expected position. Instead, the disclosed techniques may use the expected time required by the AV to traverse the sum of the waypoints (as illustrated in FIG. 9), and using the following equations:

$$R ( A {V}_{} , {m}_{j} ) = {\sum }_{k = 1}^{n} {d}_{k} and b ( A {V}_{} , {C}_{j} ) = \\ \{ \begin{matrix}1 if T ( R ( {AV}_{i} , {m}_{j} ) ) = {min}_{k} T ( R ( {AV}_{i} , {m}_{k} ) ) Λ S ( A {V}_{i} , {m}_{j} ) \\ 0 Otherwise\end{matrix} ,$$

where R (AVᵢ, mⱼ) is the total distance, i.e., the sum of the waypoints' distances, dₖ, between AVᵢ and a candidate centroid mⱼ, and T (R (AVᵢ, mⱼ)) is the expected time to reach the centroid. AVᵢ belongs to cluster Cⱼ if its expected time to reach the cluster's centroid is minimal across all the clusters and S determines if the AV can reach the centroid (approximated position for the mobile charging station) with its current charge. Put another way, function b determines whether an AV belongs to a particular cluster.

Once the above analysis has been completed, mobile stations are deployed to their assigned cluster. The disclosed techniques can be used to determine an optimal location for deploying a mobile charging infrastructure for each cluster. In some aspects, the optimal location may be closer to the centroid of such clusters. Determining this location is not only influenced by the centroids but also by the availability of convenient spaces to deploy the mobile infrastructure. Mobile infrastructure is deployed in anticipation, analyzing the time required to reach the best location for each cluster, and the estimated time in which AVs will complete their trip and move to the determined mobile location. The result is that the AVs' downtime is minimized (as illustrated in FIG. 9). The disclosed techniques may use a clustering algorithm, e.g., K-means, to guarantee that all AVs in the set of AVs that need to be charged will be assigned to a cluster, and hence, mobile charging infrastructure will cover them.

FIG. 9 illustrates diagram 900 of an example of a cluster that groups several vehicles that will be serviced by a mobile charging station, according to an example embodiment. Referring to FIG. 9, the illustrated mapped area indicates autonomous vehicles 902, expected positions 904 of AVs when the charge is below a threshold, and deployment of mobile charging stations 906.

In some embodiments, following the fleet's serviceability prediction model, recharging of the vehicles, while at the mobile hotspots, can be full or partial depending on the capacity of the mobile charges assigned to a sector, and the number of AVs to be recharged (the goal is to minimize the downtime of the AVS). Recharging stations go back to their HQs and prepare for the next round of charging. Once the disclosed techniques are used to detect that N more AVs are approaching recharging levels, processing can resume planning the next EDV deployment. In some embodiments, if AVs in the fleet have similar charge capacity and they are circulating the city from a similar starting hour, there is a high probability that the group of vehicles in the cluster will run out of charge at a similar time.

Although the disclosed techniques may be used to minimize the presence of fixed charging stations in smart cities of the future, if this type of infrastructure is available, it can be factored in in the innovation to service vehicles if that is the most efficient option available. The disclosed techniques may include recovery capabilities for AVs that have been stranded because of unpredictable circumstances.

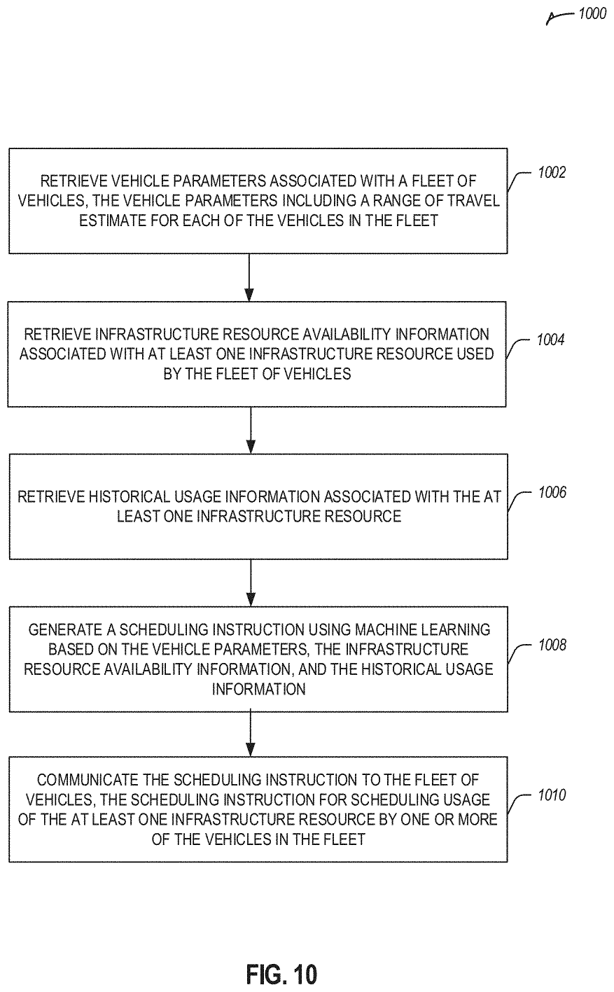

FIG. 10 is a flowchart illustrating method 1000 for managing a fleet of vehicles, according to an example embodiment. Referring to FIG. 10, method 1000 includes operations 1002, 1004, 1006, 1008, and 1010 which may performed by the MLSS 112 within the fleet management system 102. At operation 1002, vehicle parameters (e.g., fleet vehicle information 308) associated with a fleet of vehicles are retrieved. The vehicle parameters include, e.g., a range of travel estimates for each of the vehicles in the fleet. At operation 1004, infrastructure resource availability information (e.g., resource availability information 310) associated with at least one infrastructure resource used by the fleet of vehicles is retrieved. At operation 1006, historical usage information (which can be part of the resource availability information 310) associated with at least one infrastructure resource is retrieved. At operation 1008, a scheduling instruction is generated (e.g., commands 320, 322, and 324) using machine learning based on the vehicle parameters, the infrastructure resource availability information, and the historical usage information. At operation 1010, the scheduling instruction may be communicated (e.g., via the vehicle gateway 106) to the fleet of vehicles. The scheduling instruction may be used for scheduling usage of at least one infrastructure resource by one or more of the vehicles in the fleet.

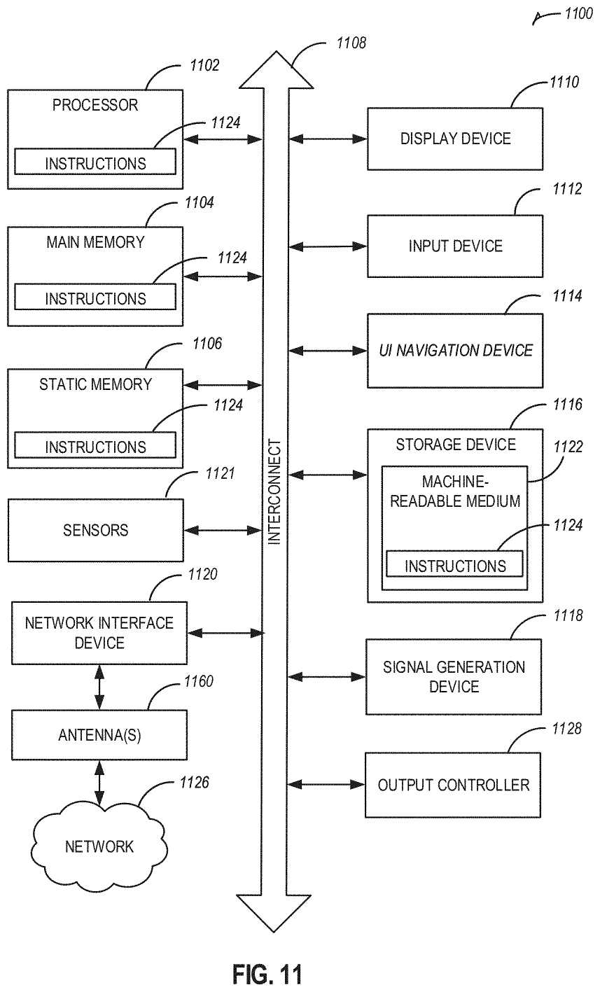

FIG. 11 is a block diagram illustrating a machine in the example form of a computer system 1100, within which a set or sequence of instructions may be executed to cause the machine to perform any one of the methodologies discussed herein, according to an embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a vehicle subsystem, a personal computer (PC), a tablet PC, a hybrid tablet, a personal digital assistant (PDA), mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

The example computer system 1100 includes at least one processor 1102 (e.g., a central processing unit (CPU), a graphics processing unit (GPU) or both, processor cores, compute nodes, etc.), a main memory 1104, and a static memory 1106, which communicate with each other via a link 1108 (e.g., bus). The computer system 1100 may further include a video display unit 1110, an alphanumeric input device 1112 (e.g., a keyboard), and a user interface (UI) navigation device 1114 (e.g., a mouse). In one embodiment, the video display unit 1110, input device 1112, and UI navigation device 1114 are incorporated into a touch screen display. The computer system 1100 may additionally include a storage device 1116 (e.g., a drive unit), a signal generation device 1118 (e.g., a speaker), a network interface device 1120, and one or more sensors (not shown), such as a global positioning system (GPS) sensor, compass, accelerometer, gyrometer, magnetometer, or other sensors. In some aspects, processor 1102 can include a main processor and a deep learning processor (e.g., used for performing deep learning functions including the neural network processing discussed hereinabove).

The storage device 1116 includes a machine-readable medium 1122 on which is stored one or more sets of data structures and instructions 1124 (e.g., software) embodying or utilized by any one or more of the methodologies or functions described herein. The instructions 1124 may also reside, completely or at least partially, within the main memory 1104, static memory 1106, and/or within the processor 1102 during execution thereof by the computer system 1100, with the main memory 1104, static memory 1106, and the processor 1102 also constituting machine-readable media.

While the machine-readable medium 1122 is illustrated in an example embodiment to be a single medium, the term “machine-readable medium” may include a single medium or multiple media (e.g., a centralized or distributed database, and/or associated caches and servers) that store the one or more instructions 1124. The term “machine-readable medium” shall also be taken to include any tangible medium that is capable of storing, encoding, or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 1124 may further be transmitted or received over a communications network 1126 using a transmission medium via the network interface device 1120 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Bluetooth, Wi-Fi, 3G, and 4G LTE/LTE-A, 5G, DSRC, or WiMAX networks). The term “transmission medium” shall be taken to include any intangible medium that is capable of storing, encoding, or carrying instructions for execution by the machine, and includes digital or analog communications signals or other intangible media to facilitate communication of such software.

In view of the disclosure above, various examples are set forth below. It should be noted that one or more features of an example, taken in isolation or combination, should be considered within the disclosure of this application.

Example 1 is a system comprising: a scheduling subsystem configured to: retrieve vehicle parameters associated with a fleet of vehicles, the vehicle parameters including a range of travel estimate for each of the vehicles in the fleet; retrieve infrastructure resource availability information associated with at least one infrastructure resource used by the fleet of vehicles; retrieve historical usage information associated with the at least one infrastructure resource; generate a scheduling instruction using machine learning based on the vehicle parameters, the infrastructure resource availability information, and the historical usage information; and communicate the scheduling instruction to the fleet of vehicles, the scheduling instruction for scheduling usage of the at least one infrastructure resource by one or more of the vehicles in the fleet.

In Example 2, the subject matter of Example 1 includes an information-sharing subsystem configured to register the infrastructure resource availability information in a database shared with the scheduling subsystem, based on a registration request from a resource owner of the at least one infrastructure resource.

In Example 3, the subject matter of Example 2 includes subject matter where the registration request further includes a usage fee and availability time for the at least one infrastructure resource.

In Example 4, the subject matter of any of Examples 2-3 includes subject matter where the scheduling instruction includes a reservation instruction for reserving the usage of the at least one infrastructure resource for a future time. and the information sharing subsystem is further configured to: communicate the reservation instruction to the resource owner of the at least one infrastructure resource.

In Example 5, the subject matter of any of Examples 2-4 includes subject matter where the at least one infrastructure resource includes one or more of: a public parking resource; a private parking resource; a fueling station resource; and an electric vehicle charging station resource.

In Example 6, the subject matter of any of Examples 1-5 includes subject matter where the vehicle parameters further include current geo-location and route information for each vehicle in the fleet of vehicles.

In Example 7, the subject matter of Example 6 includes subject matter where the vehicle parameters further include parking availability information for a public parking resource or a private parking resource in a vicinity of the current geo-location.

In Example 8, the subject matter of any of Examples 1-7 includes subject matter where the range of travel estimate includes a first range of travel estimate based on a remaining electrical charge for each of a first set of electric vehicles in the fleet and a second range of travel estimate based on a fuel level for each of a second set of non-electric vehicles in the fleet.

In Example 9, the subject matter of Example 8 includes subject matter where the scheduling subsystem is further configured to: generate a second scheduling instruction using machine learning based at least on the first range of travel estimate for each of the first set of electric vehicles, the second scheduling instruction comprises an instruction to schedule at least one energy distribution vehicle (EDV) to a current geo-location of at least one electric vehicle of the first set, the first range of travel estimate for the electric vehicle being below a threshold range.

In Example 10, the subject matter of Example 9 includes subject matter where the second scheduling instruction further comprises an instruction to schedule recharging of the at least one electric vehicle by the at least one EDV at a stationary location within a predetermined distance from the current geo-location of the electric vehicle.

In Example 11, the subject matter of any of Examples 9-10 includes subject matter where the second scheduling instruction further comprises an instruction to schedule recharging of the electric vehicle by the at least one EDV or by another electric vehicle while both the at least one EDV, or the another electric vehicle, and the electric vehicle are in motion.

In Example 12, the subject matter of any of Examples 8-11 includes subject matter where the scheduling subsystem is further configured to estimate a future demand for the first set or the second set of vehicles for a future time period and within a geographic location forming a service area using machine learning; and apply the machine learning technique to determine future serviceability of the first set or the second set of vehicles for the future time period within the geographic location using machine learning.

In Example 13, the subject matter of Example 12 includes subject matter where the future serviceability includes: an estimated electrical charge for each of the first set of electric vehicles during the future time period; and an estimated fuel level for each of the second set of non-electric vehicles during the future time period.

In Example 14, the subject matter of Example 13 includes subject matter where the scheduling subsystem is further configured to: update a map of the service area based on the estimated future demand and a fleet range prediction, the fleet range prediction based on the estimated electrical charge and the estimated fuel level; and schedule an energy distribution vehicle (EDV) to deploy to a geo-location within the service area, the geo-location associated with the estimated future demand being above a first threshold and the fleet range prediction being below a second threshold.

In Example 15, the subject matter of any of Examples 1-14 includes, the system comprising: a distributed ledger technology (DIM subsystem configured to detect the usage of the at least one infrastructure resource by a vehicle in the fleet; and record a ledger entry in a distributed ledger of the DLT subsystem, the ledger entry associated with a payment for the usage of the at least one infrastructure resource by the vehicle.

Example 16 is a computing device comprising: a network interface card (NIC); and processing circuitry coupled to the NIC, the processing circuitry configured to perform operations comprising: retrieving vehicle parameters associated with a fleet of vehicles, the vehicle parameters including a range of travel estimate for each of the vehicles in the fleet; retrieving infrastructure resource availability information associated with at least one infrastructure resource used by the fleet of vehicles; retrieving historical usage information associated with the at least one infrastructure resource; generating a scheduling instruction using machine learning based on the vehicle parameters, the infrastructure resource availability information, and the historical usage information; and communicating the scheduling instruction via the NIC to the fleet of vehicles, the scheduling instruction for scheduling usage of the at least one infrastructure resource by one or more of the vehicles in the fleet.

In Example 17, the subject matter of Example 16 includes subject matter where the range of travel estimate includes a first range of travel estimate based on a remaining electrical charge for each of a first set of electric vehicles in the fleet and a second range of travel estimate based on a fuel level for each of a second set of non-electric vehicles in the fleet, and wherein the processing circuitry is configured to perform operations comprising: generating a second scheduling instruction using machine learning-based at least on the first range of travel estimate for each of the first set of electric vehicles, the second scheduling instruction comprises an instruction to schedule an energy distribution vehicle (EDV) to a current geo-location of an electric vehicle of the first set, the first range of travel estimate for the electric vehicle being below a threshold range.

In Example 18, the subject matter of Example 17 includes subject matter where the processing circuitry is configured to perform operations comprising: estimating a future demand for the first set or the second set of vehicles for a future time period and within a geographic location forming a service area using machine learning; and determining future serviceability of the first set or the second set of vehicles for the future time period within the geographic location using machine learning; wherein the future serviceability includes an estimated electrical charge for each of the first set of electric vehicles during the future time period, and an estimated fuel level for each of the second. set of non-electric vehicles during the future time period.

In Example 19, the subject matter of Example 18 includes subject matter where the processing circuitry is configured to perform operations comprising: updating a map of the service area based on the estimated future demand and a fleet range prediction, the fleet range prediction based on the estimated electrical charge and the estimated fuel level; and scheduling an energy distribution vehicle (EDV) to deploy to a geo-location within the service area, the geo-location associated with the estimated future demand being above a first threshold and the fleet range prediction being below a second threshold.

Example 20 is at least one non-transitory machine-readable storage medium comprising instructions, wherein the instructions, when executed by processing circuitry of a computing device in a Mobility-as-a-Service (MaaS) network, cause the processing circuitry to perform operations comprising: retrieving vehicle parameters associated with a fleet of vehicles, the vehicle parameters including a range of travel estimate for each of the vehicles in the fleet; retrieving infrastructure resource availability information associated with at least one infrastructure resource used by the fleet of vehicles; retrieving historical usage information associated with the at least one infrastructure resource; generating a scheduling instruction using machine learning based on the vehicle parameters, the infrastructure resource availability information, and the historical usage information; and communicating the scheduling instruction to the fleet of vehicles, the scheduling instruction for scheduling usage of the at least one infrastructure resource by one or more of the vehicles in the fleet.

In Example 21, the subject matter of Example 20 includes subject matter where the instructions further cause the processing circuitry to perform operations comprising: detecting the usage of the at least one infrastructure resource by a vehicle in the fleet; and recording a ledger entry in a distributed ledger, the ledger entry associated with a payment for the usage of the at least one infrastructure resource by the vehicle.

Example 22 is at least one machine-readable medium including instructions that, when executed by processing circuitry, cause the processing circuitry to perform operations to implement any of Examples 1-21.

Example 23 is an apparatus comprising means to implement of any of Examples 1-21.

Example 24 is a system to implement any of Examples 1-21.

Example 25 is a method to implement any of Examples 1-21.

The above-detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof) or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A system comprising:
a scheduling subsystem configured to:
retrieve vehicle parameters associated with a fleet of vehicles, the vehicle parameters including a range of travel estimate for each of the vehicles in the fleet:
retrieve infrastructure resource availability information associated with at least one infrastructure resource used by the fleet of vehicles;
retrieve historical usage information associated with the at least one infrastructure resource;
generate a scheduling instruction using machine learning based on the vehicle parameters, the infrastructure resource availability information, and the historical usage information; and
communicate the scheduling instruction to the fleet of vehicles, the scheduling instruction for scheduling usage of the at least one infrastructure resource by one or more of the vehicles in the fleet.

2. The system of claim 1, further comprising:
an information-sharing subsystem configured to:
register the infrastructure resource availability information in a database shared with the scheduling subsystem, based on a registration request from a resource owner of the at least one infrastructure resource.

3. The system of claim 2, wherein the registration request further includes a usage fee and availability time for the at least one infrastructure resource.

4. The system of claim 2, wherein the scheduling instruction includes a reservation instruction for reserving the usage of the at least one infrastructure resource for a future time, and the information sharing subsystem is further configured to:
communicate the reservation instruction to the resource owner of the at least one infrastructure resource.

5. The system of claim 2, wherein the at least one infrastructure resource includes one or more of:
a public parking resource;
a private parking resource;
a fueling station resource; and
an electric vehicle charging station resource.

6. The system of claim 1, wherein the vehicle parameters further include current geo-location and route information for each vehicle in the fleet of vehicles.

7. The system of claim 6, wherein the vehicle parameters further include parking availability information for a public parking resource or a private parking resource in a vicinity of the current geo-location.

8. The system of claim 1, wherein the range of travel estimate includes a first range of travel estimate based on a remaining electrical charge for each of a first set of electric vehicles in the fleet and a second range of travel estimate based on a fuel level for each of a second set of non-electric vehicles in the fleet.

9. The system of claim 8, wherein the scheduling subsystem is further configured to:
generate a second scheduling instruction using machine learning based at least on the first range of travel estimate for each of the first set of electric vehicles, the second scheduling instruction comprises an instruction to schedule at least one energy distribution vehicle (EDV) to a current geo-location of at least one electric vehicle of the first set, the first range of travel estimate for the electric vehicle being below a threshold range.

10. The system of claim 9, wherein the second scheduling instruction further comprises an instruction to schedule recharging of the at least one electric vehicle by the at least one EDV at a stationary location within a predetermined distance from the current geo-location of the electric vehicle.

11. The system of claim 9, wherein the second scheduling instruction further comprises an instruction to schedule recharging of the electric vehicle by the at least one EDV or by another electric vehicle while both the at least one EDV, or the another electric vehicle, and the electric vehicle are in motion,

12. The system of claim 8, wherein the scheduling subsystem is further configured to:
estimate a future demand for the first set or the second set of vehicles for a future time period and within a geographic location forming a service area using machine learning; and
apply the machine learning technique to determine future serviceability of the first set or the second set of vehicles for the future time period within the geographic location using machine learning.

13. The system of claim 12, wherein the future serviceability includes:
an estimated electrical charge for each of the first set of electric vehicles during the future time period; and
an estimated fuel level for each of the second set of non-electric vehicles during the future time period.

4. The system of claim 13, wherein the scheduling subsystem is further configured to:
update a map of the service area based on the estimated future demand and a fleet range prediction, the fleet range prediction based on the estimated electrical charge and the estimated fuel level; and
schedule an energy distribution vehicle (EDV) to deploy to a geo-location within the service area, the geo-location associated with the estimated future demand being above a first threshold and the fleet range prediction being below a second threshold.

15. The system of claim 1, the system comprising:
a distributed ledger technology (DLT) subsystem configured to:
detect the usage of the at least one infrastructure resource by a vehicle in the fleet; and
record a ledger entry in a distributed ledger of the DLT subsystem, the ledger entry associated with a payment for the usage of the at least one infrastructure resource by the vehicle.

16. A computing device comprising:
a network interface card (NIC); and
processing circuitry coupled to the NIC, the processing circuitry configured to perform operations comprising:
retrieving vehicle parameters associated with a fleet of vehicles, the vehicle parameters including a range of travel estimate for each of the vehicles in the fleet;
retrieving infrastructure resource availability information associated with at least one infrastructure resource used by the fleet of vehicles;
retrieving historical usage information associated with the at least one infrastructure resource;
generating a scheduling instruction using machine learning based on the vehicle parameters, the infrastructure resource availability information, and the historical usage information; and
communicating the scheduling instruction via the NIC to the fleet of vehicles, the scheduling instruction for scheduling usage of the at least one infrastructure resource by one or more of the vehicles in the fleet.

17. The device of claim 16, wherein the range of travel estimate includes a first range of travel estimate based on a remaining electrical charge for each of a first set of electric vehicles in the fleet and a second range of travel estimate based on a fuel level for each of a second set of non-electric vehicles in the fleet, and wherein the processing circuitry is configured to perform operations comprising:
generating a second scheduling instruction using machine learning based at least on the first range of travel estimate for each of the first set of electric vehicles, the second scheduling instruction comprises an instruction to schedule an energy distribution vehicle (EDV) to a current geo-location of an electric vehicle of the first set, the first range of travel estimate for the electric vehicle being below a threshold range.

18. The device of claim 17, wherein the processing circuitry is configured to perform operations comprising:
estimating a future demand for the first set or the second set of vehicles for a future time period and within a geographic location forming a service area using machine learning; and
determining future serviceability of the first set or the second set of vehicles for the future time period within the geographic location using machine learning;
wherein the future serviceability includes an estimated electrical charge for each of the first set of electric vehicles during the future time period, and an estimated fuel level for each of the second set of non-electric vehicles during the future time period.

19. The device of claim 18, wherein the processing circuitry is configured to perform operations comprising:
updating a map of the service area based on the estimated future demand and a fleet range prediction, the fleet range prediction based on the estimated electrical charge and the estimated fuel level; and
scheduling an energy distribution vehicle (EDV) to deploy to a geo-location within the service area, the geo-location associated with the estimated future demand being above a first threshold and the fleet range prediction being below a second threshold.

20. At least one non-transitory machine-readable storage medium comprising instructions, wherein the instructions, when executed by processing circuitry of a computing device in a Mobility-as-a-Service (MaaS) network, cause the processing circuitry to perform operations comprising:
retrieving vehicle parameters associated with a fleet of vehicles, the vehicle parameters including a range of travel estimate for each of the vehicles in the fleet,
retrieving infrastructure resource availability information associated with at least one infrastructure resource used by the fleet of vehicles;
retrieving historical usage information associated with the at least one infrastructure resource;
generating a scheduling instruction using machine learning based on the vehicle parameters, the infrastructure resource availability information, and the historical usage information; and
communicating the scheduling instruction to the fleet of vehicles, the scheduling instruction for scheduling usage of the at least one infrastructure resource by one or more of the vehicles in the fleet.

21. The machine-readable storage medium of claim 20, wherein the instructions further cause the processing circuitry to perform operations comprising:
detecting the usage of the at least one infrastructure resource by a vehicle in the fleet; and
recording a ledger entry in a distributed ledger, the ledger entry associated with a payment for the usage of the at least one infrastructure resource by the vehicle.
